(19) United States
(12) Patent Application Publication
(10) Pub. No.: US 2025/0282270 A1
(43) Pub. Date: Sep. 11, 2025

(54) METHOD OF MANUFACTURING A SEAT STRUCTURE AND SEAT STRUCTURE FOR A MOTOR VEHICLE SEAT AS WELL AS ASSEMBLY, KIT AND MOTOR VEHICLE SEAT

(71) Applicant: Faurecia Autositze GmbH, Hannover (DE)

(72) Inventors: Przemyslaw ADAMCZYK, Gròjec (PL); Krzysztof POLAKOWSKI, Gròjec (PL); Mateusz MARCINKOWSKI, Gròjec (PL)

(21) Appl. No.: 18/986,138

(22) Filed: Dec. 18, 2024

(30) Foreign Application Priority Data
Dec. 22, 2023 (DE) 10 2023 136 624.6

(51) Int. Cl. B60N 2/68; B60N 2/02; B60N 2/90; B60R 7/04

(52) U.S. Cl. CPC B60N 2/682; B60N 2/0284; B60N 2/995; B60R 7/043

(57) ABSTRACT

A seat structure for a motor vehicle seat may include a cross member positioned close to a front edge of a seating area of the motor vehicle, a first side part connected to a first end region of the cross member and a second side part connected to a second end region of the cross member. The seat structure may further include a first and second carrier assembly. The first and second carrier assemblies may each include a carrier element with a fastening section for fastening at least one component and a bracket element fastened to the carrier element while receiving the cross member, at least in sections, between the carrier element and the bracket element. The carrier element of the first carrier assembly can be attached to the first side part and the carrier element of the second carrier assembly can be attached to the second side part.

The invention relates to a method for manufacturing a seat structure and a seat structure for a motor vehicle seat as well as an assembly, a kit and a motor vehicle seat. The motor vehicle can be a road vehicle and in particular a car, a truck or a bus.

Vehicle seats typically have a rigid seat structure to which flexible upholstery elements are attached to ensure seating comfort. The seat structure includes metallic parts, for example. It enables stable holding and support of vehicle occupants sitting on the vehicle seat. An example of a seat structure can be found at DE 10 2004 049 191 A.

It is also known to attach various additional components to the seat structure which, for example, provide functions independent of the actual seat function and/or additional comfort functions as part of the seat function. Examples of such components are a fire extinguisher or its holder and a selectively extendable calf support.

Depending on whether and which additional components are to be attached to the seat structure, a specially suitable seat structure has to be manufactured for this purpose so far. This is associated with a high manufacturing effort and correspondingly high costs.

Furthermore, the seat structure must be able to reliably withstand increased forces in the event of emergency braking and/or a collision, even if various additional components are attached to it.

Therefore, it is an object to provide a stable seat structure for the reliable attachment of additional components, the manufacturing effort and costs of which are limited, particularly in view of the large number of additional components that could potentially be attached and the resulting diversity of variants.

This object is solved by the subject-matters of the independent claims. Advantageous further embodiments are given in the dependent claims, in this description and in the figures.

Accordingly, a seat structure for a motor vehicle seat is proposed, the seat structure having:
a cross member which is positioned or can be positioned close to a front edge of a seating area of the motor vehicle seat,
a first side part, which is connected to a first end section of the cross member,
a second side part, which is connected to a second end section of the cross member,
a first carrier assembly and a second carrier assembly,

wherein the first carrier assembly and the second carrier assembly each have:
a carrier element with a fastening section for fastening at least one additional component or, in other words, an additional further component,
a bracket element, which is attached to the carrier element while at least partially receiving the cross member between the carrier element and the bracket element,

wherein the carrier element of the first carrier assembly is attached to the first side part and the carrier element of the second carrier assembly is attached to the second side part.

This solution is marked by increased stability, as the carrier assemblies are attached to both the side sections and the crossbar. An additional component can therefore be reliably supported by the seat structure even in the event of increased emergency braking and/or collision forces.

Furthermore, it is attached to easily accessible areas of the seat structure, namely to the components typically located on the outside and/or at the front in a forward driving direction in the form of the side parts and the cross member. This reduces the installation effort accordingly. In particular, the carrier assemblies can be retrofitted at low cost and/or added in a modular fashion depending on the desired seat variant.

In particular, the disclosed solution enables flexible attachment of various additional components to one and the same seat structure without the seat structure necessarily having to be adapted to a specific additional component for this purpose. One and the same seat structure can therefore preferably be combined with different additional components to achieve an increased variety of variants and modularity. However, the seat structure can preferably also be used without the carrier assembly and additional component attached to it.

Advantageously, a wide variety of additional components can be attached to one and the same carrier assembly and, more precisely, to its fastening section. In particular, this fastening can be detachable and/or at least not materially bonded. In this way, too, a wide range of variants and modularity can be achieved with reduced assembly effort.

The cross member can extend along a width direction of the vehicle. It can be cylindrical and/or elongated. According to one variant, the cross member is tubular. If a state is assumed in which the seat structure is already installed in a motor vehicle seat, in particular in combination with any upholstery elements, the cross member can be positioned close to a front edge of a seating area of the motor vehicle seat. When not yet installed, the cross member can be described as being able to be positioned close to the front edge.

The cross member can extend from one side and/or a first edge area to a second side and/or a second edge area of the seat structure and/or the motor vehicle seat. Its length can correspond to at least 75% of a width dimension of the seat structure and/or the motor vehicle seat.

The side parts can be sheet metal components and/or plate-shaped components, for example. They can extend at an angle and, in particular, essentially orthogonally to a longitudinal axis of the cross member. For example, the side parts can run along a longitudinal direction of the vehicle and/or along a longitudinal dimension of the seating area of the vehicle seat. The side parts can be mountable to a floor rail of the motor vehicle and/or connected, in particular directly connected, to a component of the motor vehicle seat that can be mounted to such a floor rail.

The vehicle seat can have a seating area and a backrest. As is known, these may be oriented or are orientable at an angle to each other. The seating area and backrest can each comprise or be formed by at least one upholstered element.

The seating area can have a front edge which, for example, forms a region of the motor vehicle seat and/or of the seating area located forward in the direction of forward travel. The seating area can have a first edge area and a second edge area, each of which extends from a position at or near the backrest to the front edge of the seating area. As described, the side parts can run in particular along these edge areas and/or overlap with them. The cross member, on the other hand, can run along the front edge and/or overlap with it.

The carrier elements can be sheet metal components, in particular bent, formed and/or stamped components. Alternatively, they can be manufactured using injection molding and/or plastic, for example. According to one variant, the carrier elements are angled components that have a first section that runs at least in sections along the side parts and, in particular, parallel to them. A second section runs at an angle to the first section and can comprise the fastening section.

The fastening section can, for example, be a plate-shaped and/or flat area. It can be positioned in front of the side parts and/or the cross member when viewed in a forward travel direction. Alternatively or additionally, the fastening section can be positioned closer to the cross member and/or a front edge of a seating area of the motor vehicle seat than to a backrest of the motor vehicle seat. This makes it possible to position additional components attached to the fastening section in corresponding front areas that are easily accessible to a vehicle occupant.

The fastening section can be marked by at least one prefabricated interface for producing a mechanical fastening of the additional component. This interface can, for example, comprise at least one hole, at least one through hole and/or at least one engagement structure. This reduces the assembly time of additional components to the seat structure accordingly and can facilitate the attachment of various additional components if they are adapted to the pre-fabricated fastening interface.

The bracket element may not have a fastening section for attaching an additional component. It cannot provide a separate function in addition to its bracket function. It can be smaller than the carrier element, for example no more than half as long or no more than a quarter as long, whereby the respective lengths can be measured in a state attached to the seat structure and in a forward driving direction. This improves handling of the bracket element and reduces its production costs.

The first and second carrier assemblies can be designed identically. Alternatively or additionally, they can be aligned and/or designed with mirror symmetry to each other. The latter can at least concern the carrier elements, whereas the bracket elements can be designed identically to each other. This reduces the number of parts accordingly and simplifies assembly. A plane of mirror symmetry can include a forward travel direction and/or a longitudinal axis of the vehicle seat. Additionally or alternatively, this plane can run centrally through the cross member and/or the seating area and/or the backrest. The plane can be vertically upright.

In principle, the carrier elements and/or the bracket elements can each be non-detachably attached to the side parts or the carrier elements. However, such a non-detachable connection is preferably made mechanically, for example with rivets, and in particular without a material bond. However, according to the embodiments discussed below, the fastening of said elements is preferably detachable.

Any detachability referred to herein may include, for example, that a connection between elements is reversibly detachable and/or restorable without destroying the elements and/or the connecting means used. Any non-detachability referred to herein may include, for example, that a connection between elements is not reversibly detachable and/or restorable without destroying the elements and/or the connecting means used.

According to one embodiment, the carrier elements are each detachably and/or non-materially bonded (or, in other words, without a material connection) to the corresponding one of the first and second side parts. For example, the carrier elements are mechanically attached to the respective side part, in particular by means of a screw connection. For example, the carrier elements are not welded or soldered to the respective side parts.

Alternatively or additionally, the bracket elements are detachably and/or non-materially bonded to a respective carrier element. For example, the bracket elements are mechanically attached to the respective carrier element, in particular by means of a screw connection. For example, the bracket elements are not welded or soldered to the respective carrier element.

The connection of the bracket element and carrier element to each other and/or their fastening to the cross member can be exclusively mechanically. In particular, this can be achieved by means of a clamping effect as a result of the cross member being received between these elements. Preferably, this connection is not made with a material bond and in particular not by welding or soldering. This also helps to reduce installation efforts and the associated costs.

As mentioned, any detachable fastening disclosed herein may comprise, in particular, a mechanical fastening, for example a screwing and/or clamping. This can be achieved in particular by holding components together between a screw bolt and a nut, thereby clamping them together. Components can also be clamped against each other by means of a screw connection and then transfer clamping forces to components received between these components. The latter can, in particular, relate to an attachment of the clamping elements and carrier elements, which can be mechanically attached to each other and, in particular, screwed together, to the cross member.

According to one embodiment, the carrier elements are each arranged opposite to and, in particular, on an inner side of the corresponding first and second side part and, in particular, are attached to this inner side. This can improve the compactness of the resulting overall arrangement. This inner side may also not be used or occupied elsewhere, or at least not completely. In particular, placement on the inside may allow that no separate adjustments to the seat structure and/or the motor vehicle seat are required, depending on whether or not the carrier assemblies disclosed herein are attached. This in turn helps to reduce assembly work and costs and to increase the number of variants without having to adapt the seat structure to individual variants,

As mentioned, according to one embodiment, the carrier elements can each be attached to the corresponding first and second side part by means of a screw connection.

According to one embodiment, the carrier element and/or the bracket element has a receiving surface shaped complementary to an outer side of the cross member. In particular, the curvature of these surfaces can be designed to complement each other. For example, the outer side of the cross member can be convexly curved and the mounting surface can be concave. A correspondingly complementary design of the mounting surface to the outside of the cross-member can achieve a large-area contact of the mounting surface with the cross-member and thus a particularly reliable fastening effect and, in particular, clamping effect.

In general, the bracket element and the carrier element can extend together along and/or abut against a portion of an outer circumference of the cross- member that is at least 50% of the entire outer circumference. Additionally or alternatively, each of the bracket element and carrier element may extend along and/or abut against at least 25% or even at least 40% of an outer circumference of the cross member. In particular, the outer circumference can be viewed in a cross-sectional plane that extends orthogonally to a longitudinal axis of the cross member.

According to one embodiment, the carrier element lies opposite an underside of the cross-member and/or rests against this underside. Alternatively or additionally, the bracket element can lie opposite an upper side of the cross member and/or rest against this upper side. The top of the cross member can be positioned vertically above the underside. The underside can face a vehicle floor. The upper side can face away from it. The corresponding arrangement of the bracket element and carrier element on the underside or upper side simplifies assembly, for example because the generally smaller bracket element does not cover the carrier element from above, or only to a limited extent. This can also result in a compact structure, as the fastening section and/or an additional component to be attached to it usually has to be positioned vertically below the cross member. In the present embodiment, the carrier element is arranged on the underside of the cross member from the outset and thus comparatively low, which enables a compact structure.

According to one embodiment, the carrier element and the bracket element are in engagement with each other. In particular, this engagement can be produced before and/or while the carrier element and the bracket element are fastened to each other. In addition or alternatively, this engagement can be produced substantially at the same time as the cross-member is received between the carrier element and the bracket element and/or before such a reception in terms of time. The engagement can comprise that one of the carrier element and bracket element has an engagement section, in particular a protruding section, which can be accommodated in a receiving section of the corresponding other of the carrier element and bracket element, in particular by producing a form fit. The receiving section can, for example, comprise a recess, such as a hole, a groove or a slot. The engagement section can, for example, protrude in the direction of the corresponding other of the carrier element and bracket element and, in particular, may be bent or angled in this direction.

By creating a corresponding engagement, the elements can be reliably positioned against each other and in a predetermined manner relative to each other while or even before they are attached to the cross member. This simplifies assembly and reduces the potential for errors.

The carrier element and the bracket element can have an area and/or a position in or at which they are attached to each other. This area or position can, for example, include at least one hole in which a mechanical fastening element (in particular a screw bolt) can be inserted for fastening the aforementioned elements to one another.

According to one embodiment, the carrier element and bracket element are attached to each other at a position that is more than 2 cm and/or not more than 5 cm away from the cross member. This distance can, for example, be measured orthogonally to a longitudinal axis of the cross member and/or to a longitudinal axis of a fastening element by means of which the carrier element and the bracket element are fastened to each other. The distance provides a lever arm so that the fastening forces generated by the fastening element can be converted into correspondingly increased clamping forces on the cross member. At the same time, limiting the maximum distance can improve compactness.

According to one embodiment, the fastening sections each have at least one through hole for fastening the additional component, in particular for receiving a fastening element for producing such a fastening. In this way, the fastening sections can provide a type of prefabricated and/or standardized mechanical interface for fastening various types of additional components.

The invention also relates to an assembly comprising:
a seat structure according to each of the aspects disclosed herein;
an additional component that is attached to at least one fastening section of the seat structure.

In particular, the additional component can be one of:
of a seat cushion longitudinal adjustment, in particular comprising a guide structure with which a distance between individual cushion elements can be varied, wherein the cushion elements are comprised by a seating area of the motor vehicle seat;
a calf rest or, in other words, calf support, in each case in particular in the form of a selectively retractable and extendable surface on which a person sitting on the motor vehicle seat can rest his legs and which is then typically in contact with the calves of this person;
of a calf support longitudinal adjustment, in particular comprising a guide structure with which a distance between individual support elements can be varied, wherein the support elements are comprised by a support surface of a calf support;
a stowage device, in particular in the form of a fixed box and/or a foldable, stowable or collapsible storage container;
a fire extinguisher and/or a holder therefor,
an umbrella, especially a pocket umbrella,
a lamp, in particular a flashlight

The invention also relates to a kit for manufacturing at least part of a seat structure according to any of the aspects disclosed herein, the kit comprising the first carrier assembly and the second carrier assembly. For example, the kit may not also include the cross member and/or the side parts and therefore only enable the manufacture of part of the seat structure. This part can be a modular add-on part comprising the carrier assemblies, whereby this part can enable the low-cost attachment of various additional components.

The invention also relates to a motor vehicle seat comprising a seat structure according to any of the aspects disclosed herein and/or an assembly according to any of the aspects disclosed herein.

Finally, the invention also relates to a method of manufacturing a seat structure for a motor vehicle seat, wherein the seat structure comprises:
a cross member which is positioned or can be positioned close to a front edge of a seating area of the motor vehicle seat,
a first side part, which is connected to a first end section of the cross member,
a second side part, which is connected to a second end section of the cross member,
a first carrier assembly and a second carrier assembly,

wherein the first carrier assembly and the second carrier assembly each have:
a carrier element with a fastening section for fastening at least one further additional component,
a bracket element,

wherein the method comprises:
Fastening the carrier element of the first carrier assembly to the first side part and receiving a section of the cross member between the bracket element and the carrier element of the first carrier assembly and fastening this bracket element and carrier element to one another;
Fastening the carrier element of the second carrier assembly to the second side part and receiving a section of the cross member between the bracket element and the carrier element of the second carrier assembly and fastening this bracket element and carrier element to each other.

The method may comprise any further features and/or measures to produce a seat structure according to any aspect disclosed herein. All explanations and further developments of features of the seat structure disclosed here can also apply to the identically worded method features.

Exemplary embodiments of the invention are explained below with reference to the accompanying schematic figures. Identical or comparable features can be provided with the same reference signs across all figures. Within the figures, several instances of a feature can be shown, but only selected instances can be provided with a reference sign that is assigned to this feature in principle.

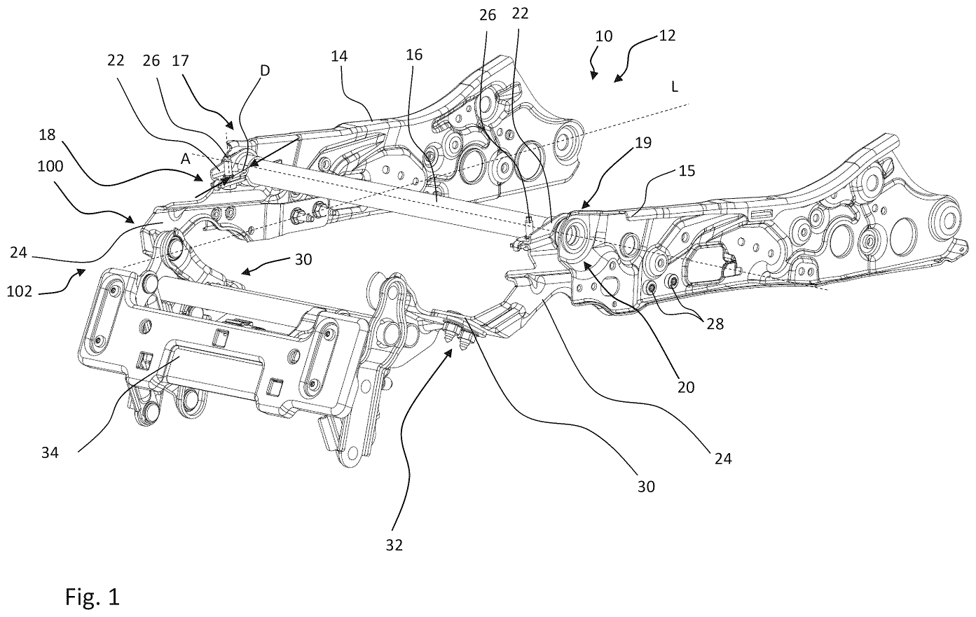

FIG. 1 shows a partial perspective view of a seat structure according to an embodiment of the invention.

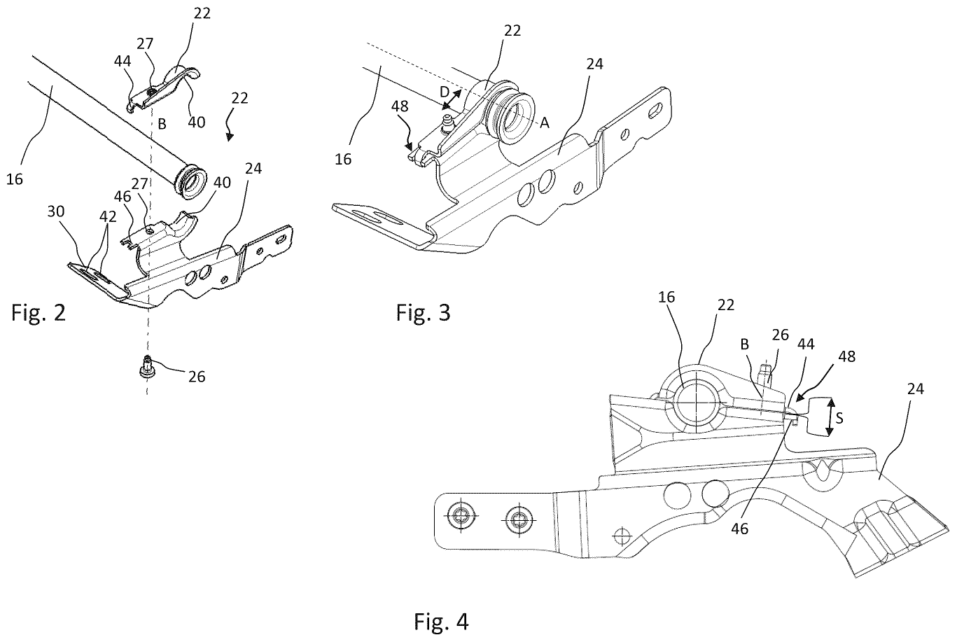

FIG. 2 shows selected components of the seat structure from FIG. 1 in an exploded view.

FIG. 3 shows the components from FIG. 2 in an assembled state.

FIG. 4 is a further view of an assembled state of components that are analogous to FIG. 2.

FIG. 1 shows part of a seat structure 10 of a motor vehicle seat 12. The vehicle seat 12 is not yet in an installable state, as in particular its upholstery elements are missing. The section shown in FIG. 1 contains in particular a part of the motor vehicle seat 12, which comprises a seating area after completion of the seat assembly. Not shown separately is a part that serves as a backrest once the seat assembly has been completed.

The seat structure 10 comprises two side parts 14, 15, which extend along outer edge regions or also outer sides and in a longitudinal direction L of the motor vehicle seat 12. This longitudinal direction L coincides with a forward direction of travel of the motor vehicle in which the motor vehicle seat 12 is installed or is to be installed. The side parts 14, 15 are sheet metal components that optionally have recesses and/or indentations and/or formed contours or punching contours, but are essentially plate-shaped. However, the side parts 14, 15 can also be made of plastic.

The seat structure 10 also comprises a cross member 16. This extends between the side parts 14, 15 and is preferably mechanically connected to each of these side parts 14, 15. More precisely, the cross member 16 comprises two end sections 17, 19 facing away from each other and which are opposite each other along its longitudinal axis A. Each of the side portions 14, 15 is mechanically connected to one of these end portions 17, 19, for example by means of an interference fit and/or a form-fit connection typically referred to as tube-end-forming. In the latter case, the ends of the cross-member 16 are formed in such a way that radially protruding stop surfaces are created, between which a section of a respective side part 14, 15 is received and/or molded in. The received section can be pushed onto a section of the cross member 16 that is not deformed, or at least only slightly deformed, and receive or enclose it in a recess, for example. Alternatively or additionally, a materially bonded connection can be provided between the side parts 14, 15 and end sections 17, 19, in particular a welded connection.

Furthermore, the cross member 16 extends at an angle to the longitudinal axis L and, in particular, orthogonally to it. This can be seen from the position of the longitudinal axis A of the cross member 16 shown in FIG. 1. In the example shown, the cross member 16 is tubular. The cross member 16 is arranged at a front end (for example in relation to a forward travel direction) of the respective side parts 14, 15. These front ends are remote from or opposite the ends of the side parts 14, 15 near the backrest not shown in FIG. 1.

The cross member 16 is also positioned at or close to a front edge of the motor vehicle seat 12 and, in particular, a seating area thereof which is yet to be completed. In particular, the cross member 16 runs closer to this front edge than to the backrest not shown in FIG. 1.

The seat structure 10 further comprises a first carrier assembly 18 and a second carrier assembly 20. These carrier assemblies 18, 20 are essentially identical, but are mirror-symmetrical to one another. A plane of mirror symmetry, which is not shown separately, runs vertically upright and contains the longitudinal axis L.

The carrier assemblies 18, 20 each comprise a bracket element 22 and a carrier element 24. The bracket element 22 and the carrier element 24 of each carrier assembly 18, 20 lie opposite each other and in sections against each other. They each receive a section of the cross member 16 between them. In the example shown, the sections of the cross member 16 received in each case lie close to or are comprised by one of the end regions 17, 19. Furthermore, the carrier assemblies 18, 20 are also positioned generally close to or overlapping with these end portions 17, 19 and close to and in particular in contact with a respective one of the side portions 14, 15.

As explained below with reference to FIG. 2, the bracket elements 22 and carrier elements 24 each have receiving surfaces 40 which are shaped complementary to the circular outer circumferential surface of that section of the cross-member 16 which is received between a respective pair of bracket element 22 and carrier element 24. In the example shown, a respective pair of bracket element 22 and carrier element 24 completely encloses an outer circumference of the accommodated section of the cross-member 16 in order to increase stability, although this is not mandatory.

The bracket element 22 and the carrier element 24 of a respective carrier assembly 18, 20 are attached to each other. In the example shown, this is done by means of a screw element 26, which is inserted into aligned holes in the bracket element 22 and carrier element 24. A bore axis B, which corresponds to a longitudinal axis of the inserted screw element 26, is shown as an example in FIG. 1. The bore axis B extends perpendicular to an opening surface of the respective aligned bores in the bracket element 22 and carrier element 24.

It can be seen that a fastening position of the bracket element 22 and carrier element 24, which lies along the bore axis B or corresponds to a position of the screw element 26, lies at a distance D from the longitudinal axis A of the cross-member 16 (see also FIG. 3). In the case shown, the longitudinal axis A runs centrally through the cross-member 16, in particular with its tubular cross-section extending concentrically around the longitudinal axis A. The distance D defines a lever arm by means of which the fastening forces generated by the screw element 26 can be converted into correspondingly increased clamping forces between the bracket element 22, the carrier element 24 and the cross member 16.

The carrier elements 24 are each arranged on the inner side of the associated side parts 14, 15 and contact it. Furthermore, they are attached to an associated side part 14, 15 by means of at least one screw connection 28. The carrier elements 24 are therefore fastened both to the cross member 16 and in the side parts 14, 15. This enables a particularly high and reliable absorption of forces by the carrier elements 24, which significantly reduces the risk of them slipping, for example.

In the example shown, the carrier elements 24 are sheet metal components that are essentially plate-shaped, at least along the side parts 14, 15. They extend forwards and away from the side parts 14, 15 and along the longitudinal axis L. The carrier elements 24 each have a fastening section 30. In the example shown, the fastening sections 30 are each angled with respect to adjacent areas of a respective carrier element 24, so that they provide a fastening surface facing the vehicle floor and facing away from it. As a result of the described extension of the carrier elements 24, the fastening sections 30 are positioned in front of the cross member 16 and the side parts 14, 15 and, in particular, further away from a backrest, which is not shown, than these components.

The fastening sections 30 have non-depicted through holes in which fastening elements 32 are inserted for fastening an additional component 34. In the example shown, the additional component 34 is an extendable calf support comprising various movable components that are not explained in detail here. FIG. 1 shows a retracted state of this additional component 34. Other additional components 34, in particular according to any of the examples mentioned herein, may be attached to the fastening sections 30 instead of the calf support shown, without the need to separately adapt these fastening sections 30. Instead, it is sufficient if the additional components 34 have openings which can be arranged in alignment with the through holes of the fastening sections 30 for the purpose of receiving the fastening means 32 together.

The seat structure 10 and the additional component 34 form an assembly 100 of the type disclosed herein. A kit 102 of the type disclosed herein includes the carrier assemblies 18, 20. Such a kit 102 can, for example, be supplied to a production line for the manufacture of desired seat variants. Alternatively or additionally, such a kit 102 may be provided as a retrofit kit for attaching desired additional components 34 to an already installed motor vehicle seat 12.

It is clear from the above that the carrier assemblies 18, 20 can be attached to an existing seat structure 10 with little effort and, for example, by means of manual and/or purely mechanical assembly steps and, in particular, can only be added as required. However, the seat structure 10 can also be used without carrier assemblies 18, 20 to form a motor vehicle seat.

Existing designs of seat structures 10 can also continue to be used with only minor, if any, modifications. Such modifications may be necessary, for example, to enable the carrier elements 24 to be attached to the side parts 14, 15.

Furthermore, the carrier assemblies 18, 20 can be coupled with a wide variety of additional components 34, which increases the number of variants that can be achieved without extensive and/or variant-specific changes to the seat structure 10.

Finally, the carrier assemblies 18, 20 are redundantly attached and attached to different components within the seat structure 10, which increases their mechanical load-bearing capacity.

FIG. 2 shows part of the seat structure 10 in an exploded view. More precisely, the second carrier assembly 22 is shown together with the cross member 16. In this view, the receiving surfaces 40 of the bracket element 22 and of the carrier element 24 are recognizable, which are shaped to complement the outer circumferential surface of the cross-member 16 and which can be brought into contact with the latter. In the example shown, the receiving surfaces 40 are concave and/or correspond to sections of a circular cylindrical inner surface. It is also clear that the bracket element 22 rests against the cross-member 16 from above, whereas the carrier element 24 rests against the cross-member 16 from below.

Furthermore, FIG. 2 shows the openings 42 in the fastening section 30, into which the fastening means 32 of FIG. 1 can be inserted for attaching the additional component 34.

In addition, the bores 27 in the bracket element 22 and the carrier element 24 are visible, which can be arranged in alignment with one another along a bore axis B.

FIG. 2 also shows a protruding section 44 on the bracket element 22, in particular in the form of an angled protrusion, a hook and/or a retaining lug. In contrast, a slot-shaped recess 46 is provided in the carrier element 24.

FIG. 3, which shows the components of FIG. 2 in an assembled state, illustrates that the protruding section 44 and the recess 46 form an engagement structure 48, since they can be brought into engagement with one another. This allows the bracket element 22 and the carrier element 24 to be aligned with one another in a defined manner during assembly and, in particular, before they are fastened to one another, and also to be held together at least temporarily.

FIG. 4 shows a further view of an assembled state, but in comparison to FIG. 3 as a side view and of the carrier element 24 opposite the carrier element 24 of FIG. 3. This view again clearly shows the engagement structure 48 formed by the protruding section 44 and the recess 46.

In addition, a gap S that has already been largely closed by tightening the screw element 26 is marked in FIG. 4. This is present to a significantly greater extent before the screw element 26 is inserted and tightened between the facing surfaces of the bracket element 22 and carrier element 24, which are at least partially brought into contact. The clamping forces generated depend largely on the position of the screw element 26 and the associated lever arm discussed above, as well as the extent to which the screw element 26 is tightened and the associated reduction in the gap S.

1. A seat structure for a motor vehicle seat, the seat structure comprising:
a cross member positioned or positionable close to a front edge of a seating area of the motor vehicle seat;
a first side part connected to a first end region of the cross member;
a second side part connected to a second end region of the cross member;
a first carrier assembly; and
a second carrier assembly, wherein the first carrier assembly and the second carrier assembly each comprise:
a carrier with a fastening section for fastening at least one component; and
a bracket element which is fastened to the carrier while receiving the cross member at least in sections between the carrier and the bracket, wherein the carrier of the first carrier assembly is attached to the first side part and the carrier of the second carrier assembly is attached to the second side part.

2. The seat structure according to claim 1, wherein at least one of: i) the carriers are each at least one of detachably or non-materially bonded to a corresponding one of the first side part or second side part or ii) the brackets are each at least one of detachably or non-positively attached to the carrier.

3. The seat structure according to claim 1, wherein the carriers are each at least one of: i) arranged opposite an inner side of a corresponding first side part or second side part ii) fastened to the inner side.

4. The seat structure according to claim 1, wherein the carriers are each fastened to a corresponding first side part or second side part by a screw connection.

5. The seat structure according to claim 1, wherein at least one of the carriers or the brackets each have a receiving surface shaped complementarily to an outer side of the cross member.

6. The seat structure according to claim 1, wherein at least one of: i) the carriers each lie opposite an underside of the cross member or ii) the brackets each lie opposite an upper side of the cross member.

7. The seat structure according to claim 1, wherein the carrier and the bracket of a respective carrier assembly are in engagement with one another.

8. The seat structure according to claim 1, wherein the carrier and bracket of a respective carrier assembly are fastened to one another at a position which has a distance of one or more of: i) more than 2 cm or ii) not more than 5 cm from the cross member.

9. The seat structure according to claim 1, wherein the fastening section of a respective carrier has at least one through hole for receiving a fastening member for fastening the at least one component.

10. An assembly, comprising:
a seat structure, the seat structure comprising:
a cross member positioned or positionable close to a front edge of a seating area of a motor vehicle seat;
a first side part connected to a first end region of the cross member;
a second side part connected to a second end region of the cross member;
a first carrier assembly; and
a second carrier assembly, wherein the first carrier assembly and the second carrier assembly each comprise:
a carrier with a fastening section for fastening at least one component; and
a bracket fastened to the carrier while receiving the cross member at least in sections between the carrier and the bracket, wherein the carrier of the first carrier assembly is attached to the first side part and the carrier of the second carrier assembly is attached to the second side part; and
an additional component attached to the fastening section of the seat structure.

11. The assembly according to claim 10, wherein the additional component is one of:
a seat cushion length adjustment;
a calf rest and/or calf support:
a calf support length adjustment:
a stowage device;
a fire extinguisher and/or a fire extinguisher holder;
an umbrella; or
a flashlight.

12. A kit for manufacturing at least a part of a seat structure comprising:
a cross member positioned or positionable close to a front edge of a seating area of a motor vehicle seat;
a first side part connected to a first end region of the cross member:
a second side part connected to a second end region of the cross member;
a first carrier assembly; and
a second carrier assembly, wherein the first carrier assembly and the second carrier assembly each comprise:
a carrier with a fastening section for fastening at least one component; and
a bracket fastened to the carrier while receiving the cross member at least in sections between the carrier and the bracket, wherein the carrier of the first carrier assembly is attached to the first side part and the carrier of the second carrier assembly is attached to the second side part; and wherein the kit comprises the first carrier assembly and the second carrier assembly.

13. The seat structure according to claim 1, wherein the seat structure is included in an assembly, the assembly comprising:
an additional component attached to the fastening section of the seat structure.

14. A method of manufacturing a seat structure for a motor vehicle seat , the seat structure comprising:
a cross member positioned or positionable close to a front edge of a seating area of the motor vehicle seat;
a first side part connected to a first end region of the cross member;
a second side part connected to a second end region of the cross member;
a first carrier assembly; and
a second carrier assembly, wherein the first carrier assembly and the second carrier assembly each comprise:
a carrier with a fastening section for fastening at least one component; and
a bracket, wherein the method comprises:
fastening the carrier of the first carrier assembly to the first side part
receiving a portion of the cross member between the bracket and the carrier of the first carrier assembly;
attaching the bracket and carrier to each other;
fastening the carrier element of the second carrier assembly to the second side part;
receiving a section of the cross member between the bracket and the carrier of the second carrier assembly; and
fastening the this bracket and carrier to one another.
